(19) United States
(12) Patent Application Publication
(10) Pub. No.: US 2015/0250358 A1
(43) Pub. Date: Sep. 10, 2015

(54) Grill Pan for Cooking

(71) Applicant: Arturo Rivera Ortegon, Sabinas (MX)

(72) Inventor: Arturo Rivera Ortegon, Sabinas (MX)

(21) Appl. No.: 14/643,851

(22) Filed: Mar. 10, 2015

(30) Foreign Application Priority Data
Mar. 10, 2014 (MX) MX/U/2014/000110

(51) Int. Cl. A47J 37/07

(52) U.S. Cl. CPC A47J 37/0763

(57) ABSTRACT

Grill pan for cooking, where the functionality of a pan and a grill is found in one single product and which may come in different shapes and sizes and preferably has a solid flat surface with a number of holes distributed all over its surface and a wall on its circumference and on this surface, and it additionally has a handle or part for its handling.

### PURPOSE OF INVENTION

The purpose of this invention is to provide a grill pan alternative for cooking, which may allow us to cook differently from the conventional manner, in less time and give the feeling of cooking on a grill.

### BACKGROUND

There is a wide variety of different cooking pans in the market, they come in different shapes and sizes and generally have a solid flat surface and a wall on their circumference and on this surface, and they additionally have a handle or part for their handling. On the other hand, there is also a wide array of grills in different shapes and sizes which are generally made up by a flat surface with different openings in addition to a handle or part for its handling, use and storage as well, so our invention is a product that contains both concepts and this will provide the user with versatility when cooking, translating into saving time, space and less products available to be controlled, achieving an evident wellbeing and practicality.

### BRIEF DESCRIPTION OF FIGURES

FIG. 1. It shows a top view of the grill pan for cooking, depicting a number of holes on its solid flat surface.

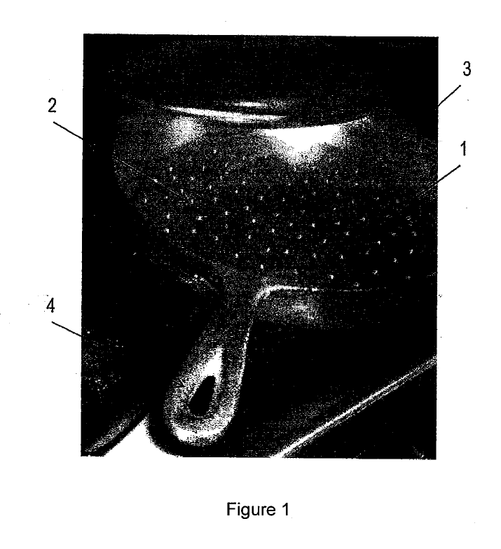

### DETAILED DESCRIPTION OF INVENTION

Grill pan for cooking where the functionality of a pan and a grill is found in one single product and which comes in different shapes and sizes and preferably has a solid flat surface (1), with a number of holes (2), distributed all over its surface and a wall (3) on its circumference and on this surface, and it additionally has a handle or part (4) for its handling. The function of these holes is that they allow for direct contact with the fire so the food contained in the grill pan may be cooked and grilled at the same time.

1. Grill pan for cooking characterized because it is made up of a structure in different shapes and sizes and it preferably has a solid flat surface with a number of holes distributed all over its surface and a wall on its circumference and on this surface and it additionally has a handle or part for its handling. The function of these holes is to allow for direct contact with the fire so the food contained in the grill pan may be cooked and grilled at the same time.

2. Grill pan for cooking pursuant to claim #1, characterized because for its operation it includes holes on the surface of the grill pan for cooking which allow for direct contact with the fire so the food contained in the grill pan may be cooked and grilled at the same time.
